(19) United States
(12) Patent Application Publication
(10) Pub. No.: US 2006/0184792 A1
(43) Pub. Date: Aug. 17, 2006

(54) Protecting computer systems from unwanted software

(75) Inventor: Jay H. Berlin, Houston, TX (US)

Correspondence Address: MEYERTONS, HOOD, KIVLIN, KOWERT & GOETZEL, P.C., 700 LAVACA, SUITE 800, AUSTIN, TX, 78701, US

(73) Assignee: Scalable Software

(21) Appl. No.: 11/060,344

(22) Filed: Feb. 17, 2005

(51) Int. Cl. H04N 7/16; H04L 9/00; H04L 9/32; G06F 17/30; G06F 7/04; G06K 9/00; H03M 1/68; H04K 1/00

(52) U.S. Cl. 713/165; 713/166; 713/167; 726/26

(57) ABSTRACT

A method for protecting one or more computer systems from unwanted software. A protection server computer maintains an approved list identifying a plurality of process files approved for execution. The protection server distributes an agent software program and the approved list to each of a plurality of computer systems. When a first computer system receives a request to execute a first process file, the agent software program intercepts the request and ensures that the first process file is on the approved list. The agent may also check a forbidden list of known bad software to ensure that undesired software is not executed. The approved list may be created by first configuring a securely managed “golden machine” with software (process files) intended to be used by computer systems in the enterprise. The approved list may then be created based on the known good process files stored on the golden machine.

### FIELD OF THE INVENTION

The present invention relates generally to a software tool to protect desktops and servers within the enterprise from unwanted software, including both known and unknown viruses, process-based worms, spy-ware and mal-ware.

### DESCRIPTION OF THE RELATED ART

Modern computer systems are plagued by a variety of undesired software programs that in many instances are surreptitiously installed and executed. Examples of this unwanted software include viruses, process-based worms, spy-ware and mal-ware, among others.

Modern computer systems typically execute a variety of different software applications, and many times multiple applications are executed concurrently. Each time an application is launched, one or more software processes may be invoked to enable execution of the application. A process is a distinctly loaded entity on a computer. FIG. 1A illustrates an example of the Applications tab of Windows Task Manager. As shown, two Applications are running, these being Microsoft Outlook and a software program called WiFi Planet. FIG. 1B illustrates an example of the Processes tab of Windows Task Manager. The Processes tab lists all of the processes currently running on a machine. Notice there are many processes running, even when there are just a few applications running.

Every time a user starts or launches an application, at least one corresponding process-execution-request is made from the operating system to ‘run something’. In fact, to run a single application, such as Microsoft Word, there are almost always several process-execution-requests made. This is because not only does the .exe file (such as winword.exe) get ‘run’ or executed, but various of associated and required .dll (“dynamic link library” or shared library) files which are libraries of executable functions and/or data that can be used by the application are loaded by the operating system as well. The loading of each of these .dll files can be considered a process-execution-request. There are also many requests that are not user-initiated, but are requested by other applications or the operating system itself. As can be seen from the process list in the Task Manager picture of FIG. 1B, many processes are running that were not user-initiated.

Current computer system protection products on the market today address the issue of protecting a user's computer from “bad” things running on it by looking for these bad things. For example, virus-scanners look for specific signatures in the code of each process that is run, and spy-ware removal tools look for known spy-ware that may reside on your computer. The problem with this approach is that, by looking for known bad (e.g., unwanted or undesired) software programs, the protection software always has to have knowledge of the bad programs for it to be found or identified. This means that signature-definition-files and spy-ware-definition-files must be kept up-to-date by the software vendor of these products, and they must be up-to-date on all protected computers in the enterprise. The updating of protection software is getting more difficult as the number of viruses and virus variants and spy-ware applications continues to increase. Even with billions of dollars being spent on virus and mal-ware protection, serious virus outbreaks continue to occur at ever increasing rates. Keeping up with spy-ware removal is becoming an even harder task due to the following issues with spy-ware removal tools:

1) They are unable to keep up with the rapid proliferation of spy-ware applications;

2) They are not designed as enterprise-scale tools with centralized reporting and control;

3) These tools currently do not do a very thorough job of actually removing spy-ware from a machine;

4) These tools typically do not prevent spy-ware from being installed, they simply attempt to remove it once it exists; and

5) Since spy-ware is often installed as a result of simple web-browsing, cleaning out spy-ware is often a daily ritual as the spy-ware continues to come back.

Therefore, improved methods are desired for creating and managing protection related software. In particular, there is a need for improved protection software which prevents unwanted software from being installed on computer systems.

### SUMMARY OF THE INVENTION

Various embodiments are disclosed relating to a method, system and memory medium for protecting one or more computer systems from unwanted software.

A protection server computer may maintain a data structure, referred to as the approved list, which identifies a plurality of process files that are approved for execution. Thus the approved list may comprise a list of known good process files. The protection server may distribute an agent software program and the approved list to each of a plurality of computer systems.

A first computer system may then receive a request to execute a first process file. The agent software program may intercept the request and determine if the first process file is on the approved list. If the first process file is on the approved list, the agent software program may allow the first process file to run on the first computer system. If the first process file is not on the approved list, the agent software program may prevent the first process file from executing, or may prompt the user to decide if the first process file should be allowed to execute.

The agent software program may also determine if the first process file is on a forbidden list, e.g., a list of process files that are known to be undesired or malicious. If the first process file is on the forbidden list, the agent software program may prevent or block execution of the first process file.

If the first process file is not on either of the approved list or the forbidden list, the agent software program may either determine if approval should be requested for the first process file or automatically requesting approval of the first process file. In one embodiment, if the first process file is not on the approved list or the forbidden list, then the agent software program may enable execution of the first process file in a quarantined environment. In the quarantined environment the first process file is not allowed access to one or more resources of the first computer system, such as network access, registry update access, file write access, and file execution access, among others. The user may be able to configure a level of the quarantined environment that determines which of the one or more resources are allowed by the first computer system.

The approved list may be created in various ways. In one embodiment, a computer system referred to as a “golden machine” may be configured with a plurality of process files that are intended to be used by computer systems in the enterprise. The “golden machine” computer system is preferably managed to prevent unwanted software from being stored on the computer system. After the golden machine is configured, the method may determine process files stored on the golden machine and use the information regarding the determined process files to create and/or update the approved list. As additional software programs are installed on the golden machine, additional process files may be determined and added to the approved list. The approved list may also at least partially or completely be created based on information from a server computer, such as a server maintained by a software vendor that provides information on approved process files of that software vendor. As the software vendor releases new updates or new software programs, the software vendor may update its respective list of approved process files (its approved list) accordingly.

The forbidden list may be created and/or updated based on information on undesired software. For example, the forbidden list may be updated as undesired software is discovered.

The protection software described herein thus takes a different approach to protecting the enterprise. Instead of looking for known-bad things, the protection software ensures that only known-good things are allowed to run in the environment. This keeps the administrator from having to maintain constantly changing signature and definition files across the entire enterprise and rely on vendors to keep these lists up-to-date.

### BRIEF DESCRIPTION OF THE DRAWINGS

A better understanding of the present invention can be obtained when the following detailed description of the preferred embodiment is considered in conjunction with the following drawings, in which:

FIG. 1A illustrates the Applications tab of a Windows Task Manager, which shows two applications;

FIG. 1B illustrates the Processes tab of a Windows Task Manager, which displays a plurality of processes associated with the two applications shown the Applications tab of FIG. 1A;

FIG. 2 is a block diagram of an exemplary enterprise system comprising protection software, according to various embodiments;

FIG. 3 illustrates high level operation of the protection software, according to various embodiments;

FIG. 4A is a flowchart diagram of a method for creating an enterprise configuration, according to various embodiments;

FIG. 4B is a flowchart diagram of a method for creating an Approved List, according to various embodiments;

FIG. 5 is an exemplary block diagram of a computer system comprising protection software, according to various embodiments;

FIGS. 6A-6B illustrate a flowchart diagram of a method for initializing protection software, according to various embodiments;

FIG. 7 illustrate a flowchart diagram of a method for intercepting and handling a process request, according to various embodiments;

FIG. 8 illustrates a flowchart diagram of a method for handling a request to execute a process file which is in an approved list, according to various embodiments;

FIGS. 9A-9B illustrate a flowchart diagram of a method for handling a request to execute a process file which is in a forbidden list, according to various embodiments;

FIGS. 10A-10B illustrate a flowchart diagram of a method for handling a request to execute a process file which is unidentified, according to various embodiments;

FIG. 11 is an exemplary diagram of a configuration file comprising configuration information, according to various embodiments;

FIG. 12 is an exemplary diagram of an Approved List file comprising approved process file information, according to various embodiments; and

FIG. 13 is an exemplary diagram of a Forbidden List file comprising forbidden process file information, according to various embodiments.

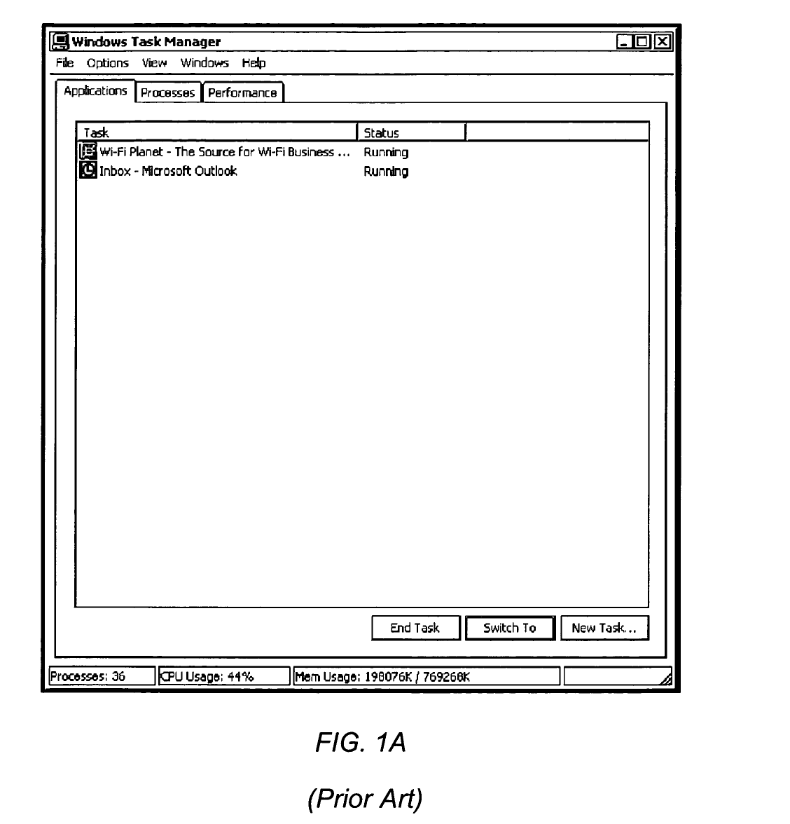

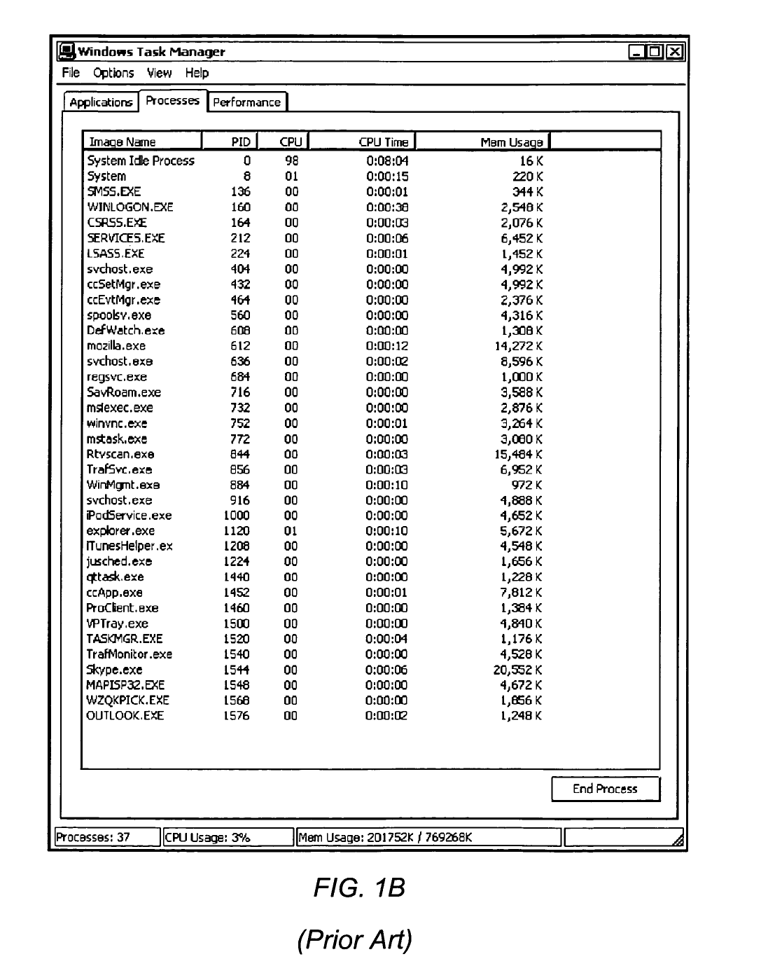

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Process File—the term “process file” is intended to have the full breadth of its ordinary meaning, and includes any type of storage object that stores program instructions, a software program, a software process, a Windows and/or DOS executable (e.g., ‘.exe’), a library, a dynamically linked library (e.g., ‘.dll’ files), a shared library, a set of pre-compiled routines (e.g., a module which is stored in an object code format), an OLE control extension (‘.ocx’), code, a software object, a script and/or data, or combinations thereof, that may be stored in a memory medium and executed by a processor.

Computer System—any of various types of computing or processing systems, including a personal computer system (PC), server computer system, mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

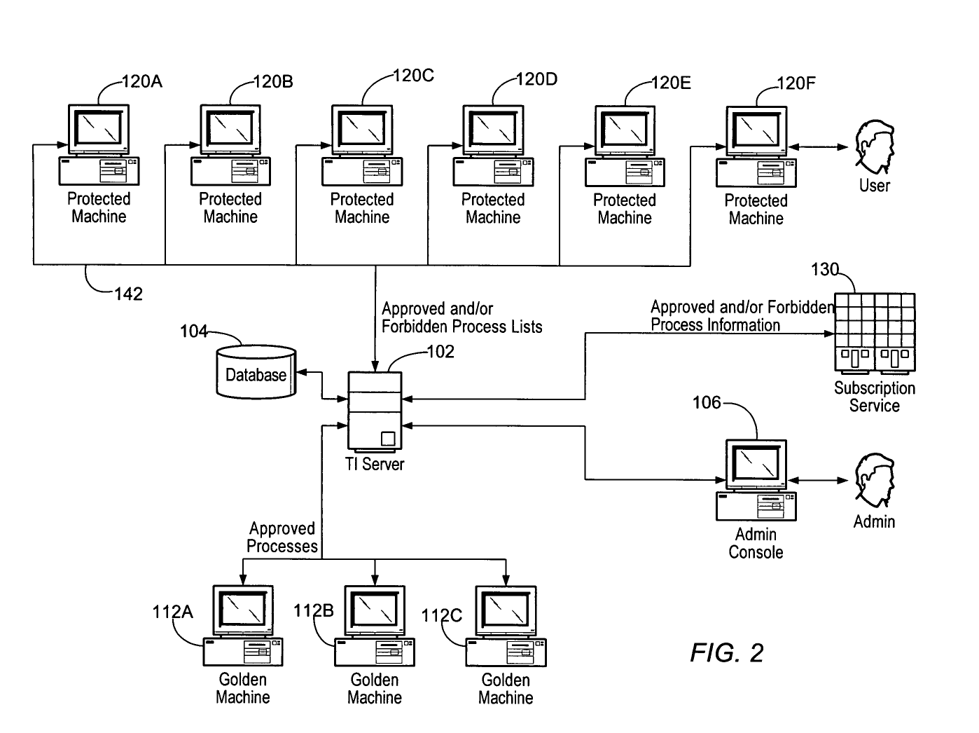

FIG. 2—Enterprise System

FIG. 2 illustrates an exemplary embodiment of a system which may use embodiments of the present invention. In the present application, embodiments of the protection software of the present invention are sometimes referred to as the TotalImmunity software. FIG. 2 shows a high-level view of the protection software running within an enterprise. As shown, the enterprise system comprises a server 102, referred to as the TotalImmunity Server (TI Server). The TI Server 102 may couple to a database 104, e.g., over a network 142. In some embodiments, TI Server 102 may comprise database 104. An Administrator console 106 may couple to the TI Server 102, wherein the Administrator console 106 may be operated by an Administrator. In one embodiment, the Administrator may have complete control over Approved and Forbidden lists (discussed below), so that new process files may be manually added to either list and existing process files may be moved between the lists or completely removed from a list.

The term “Approved List” refers to a list or other data structure stored on at least one memory medium that identifies approved process files, e.g., process files that are approved for execution. The “Approved List” may be distributed among two or more memory mediums, e.g., a first portion of the Approved List may be stored on a first memory medium, and a second portion of the Approved List may be stored on a second memory medium. The “Approved List” may take various forms and may be updated in various ways.

The term “Forbidden List” refers to a list or other data structure stored on at least one memory medium that identifies process files that are one or more of not approved, undesired, or forbidden, e.g., process files that are desired to be prevented from execution. The “Forbidden List” may be distributed among two or more memory mediums, e.g., a first portion of the Forbidden List may be stored on a first memory medium, and a second portion of the Forbidden List may be stored on a second memory medium. The “Forbidden List” may take various forms and may be updated in various ways.

One or more computer systems (referred to as “Golden Machines”) 112A-112C may be coupled to the TI Server 102 over network 142. In various embodiments, Golden Machines 112A-112C may be used to identify various process files for a list of Approved process files. The protection software may operate to scan for process files that are installed on the one or more Golden Machines 112A-112C to generate an Approved List. In addition, one or more computer systems (referred to as “Protected Machines”) 120A-120F may be coupled to the TI Server 102 over the network 142. One or more of the Golden Machines 112 may be located at the same location as the TI Server 102, or may be located at a remote location and connected to the TI Server 102 over a wide area network, such as the Internet.

For example, certain software vendors may maintain “Golden Machines” that have approved process files of that vendor. In this embodiment, the TI Server 102 may access one or more different vendor's Golden Machine 112 to populate the Approved List. In this embodiment, the TI Server 102 may access a combination of vendor Golden Machines to obtain approved processes from certain software vendors, and may access Golden Machines 112 in the respective enterprise, that contain approved processes for various other software, such as from smaller software vendors, non-standard software, and others. Alternatively, as discussed below, different software vendors may maintain Approved Lists for process files associated with their respective software. The TI Server 102 may access different Approved Lists from different software vendors to update the respective Approved List maintained by the TI Server 102.

TI Server 102 may store the protection (TotalImmunity) software according to one embodiment of the invention. TI Server 102 may perform the following functions:

Store, manage and sign Approved and/or Forbidden Lists;

Perform network discovery scans;

Install and manage protected machine and golden machine agents;

Store configuration values;

Display Audit Reports; and/or

Retrieve periodic updates from a Subscription Service.

When TI Server 102 is initially installed, a public-private key pair for the server may be generated. When an agent software program is installed on either a Golden Machine 112A or a Protected Machine 120A, the public key may be sent to the agent. The private key may be used to sign any of the data that is transmitted to the agents, including the entries in the Approved and Forbidden Lists so that the agents can ensure that the data that is received is valid, from the TI Server 102 and has not been tampered with.

Database 104 may store data used by the TI server 102, including the Approved List, the Forbidden List, and other software. Various database tables may be stored in database 104 which may comprise a machine table of discovered machines, an agent table of Golden Machines and protected machines, a configuration table of named configuration values, an Approved List table of entries of an Approved List, a Forbidden List table of entries of a Forbidden List (e.g., each entry may be marked as either active or pending approval), an approve pending table of entries that are pending administrator approval, an audit log table of audit entries from various protected machines, a security table of user roles and permissions which may be used in performing various TotalImmunity software functions, and an override keys table of override keys assigned to users which may include a user name, a key and machine restrictions on use of key (if any), among others.

An Approved List (a list of Approved process files for the enterprise) may be created and managed in various ways. In one embodiment of the protection software, an administrator is allowed to select a set of one or more machines that are well-protected and closely managed and comprise the process files that may be used throughout the enterprise. These machines are often known as source-image machines. In the present application, these machines are referred to as “Golden Machines” 1 12A-112C, since they comprise the golden images for the enterprise. As used herein, the term “golden machine” refers to a computer system that comprises process files that are used in at least a subset of the enterprise, and wherein the computer system is managed to attempt to prevent unwanted software from being installed or loaded on the computer system. A Golden Machine 112 may be managed by (within) the enterprise or by a software vendor.

Admin Console (TI Console) 106 may be the user interface used to access the TI Server 102. An Administrator may use TI Console 106 to interface to TI Server 102 and control the operations of the protection software described herein. TI Console 106 may be coupled directly to the TI Server 102, e.g., they may be in the same room or building, or TI Console 106 may couple to the TI Server 102 over a network, such as the Internet. In various embodiments, computer systems described herein may communicate with one another using use one or more secure methods and/or systems such that the one or more secure methods and/or systems may prevent and/or reduce the risk of communication eavesdropping, tampering, and/or forgery. For example, the computer systems described herein may communicate with one another using transport layer security (TLS), HTTPS (secure HTTP), and/or a secure socket layer (SSL), among others.

As noted above, one or more computer systems such as one or more Golden Machine(s) 112A-112C may be used to populate the list of approved process files. Any process file located on (stored on) a Golden Machine 112 may be considered to be approved to execute within the enterprise on any of the Protected Machines 120A-120F. In addition, the TI Server 102 may be configured to automatically add any new process file that is installed on one of the Golden Machines 1112A-112C to the Approved list or require that any newly installed process from one of the Golden Machines 112A-112C be approved by the Administrator before it is added to the Approved list. The TI Server 102 installs a Golden Machine Agent on each of the Golden Machines 112A-112C.

The Golden Machine Agent may perform the following functions:
Scan the local hard drives for all process files (e.g., .exe, .dll, .com, .ocx, etc.);
Scan network storage (e.g., network drive(s), etc.); and
Calculate a TotalImmunity Identification for each process file which may be used to uniquely identify the process file.

For instance, a TotalImmunity Identification for a process file may include a format which may comprise one or more of a name of the process file, a size of the process file, and a hash value of contents of the process file, among others. The hash value may be used to identify the file and may be used in comparing process files that are requested to be executed. In some embodiments, a hash value may be a fixed-length numeric value for input information (e.g., a string of characters, contents of a file, combinations thereof, among others), and the hash value may be a value from a hash function (e.g., SHA-1, MD2, MD5, etc.). A hash function may be considered useful if it is “one-way” or “hard to invert”, where “hard to invert” may mean that it may be computationally difficult or infeasible to determine input information (e.g., a string of characters, contents of a file, etc.) from some hash value.

Protected Machines 120A-120F refer to the various computer systems comprised within the enterprise that are desired to be protected from undesired or unwanted software using the protection software described herein. For example, Protected Machine 120A may be a machine that is running protection software such as Protection Agent 200. TI Server 102 may install a Protection Agent 200 on each of the Protected Machine 120A-120F.

Protection Agent 200 may perform the following functions:
Communicate with TI Server 102 to retrieve the Approved and/or Forbidden lists;
Respond to process-requests such that:
   any process on the Approved List is allowed to execute;
   any process on the Forbidden List is blocked from executing; and
   any unidentified process is handled according to a policy, e.g., an administrator specified policy, for handling unidentified processes (described in detail below); and
Audit responses taken for process-requests by sending information to TI Server 102 (this information is used for generating various Audit Reports).

In some embodiments, the system may include a server 130 which may provide updates to the Approved List and/or the Forbidden List. This service may be a subscription service and may further enhance the quality of the Approved and/or Forbidden lists at a TI Server installation. The subscription service server 130 may be continuously or periodically updated with a list of Approved commercial process files and known Forbidden process files (e.g., new spyware, viruses, etc.). These lists are preferably comprehensive, up-to-date lists and are made available to the TI Server 102 to periodically download and integrate with the existing lists. Similar to the Golden Machine support, an administrator may choose to automatically add process files from the Subscription Service to the enterprise environment, or an administrator may require manual approval of the entries on each list before they are added.

In one embodiment, one or more of TI server 102 and the subscription service server 130 may periodically query and/or receive updates to the Approved list and the Forbidden list from various software vendors, such as Microsoft, Sun, Oracle, etc. In this embodiment, when a software vendor releases a new or updated software product, the software vendor may also release an update (a digitally signed and verified update) for the Approved list, wherein the update comprises information regarding the various process files comprised in and/or invoked by the new or updated software. Thus, the Approved List and/or the subscription service server 130 may be dynamically updated by various software vendors as new or updated software releases occur.

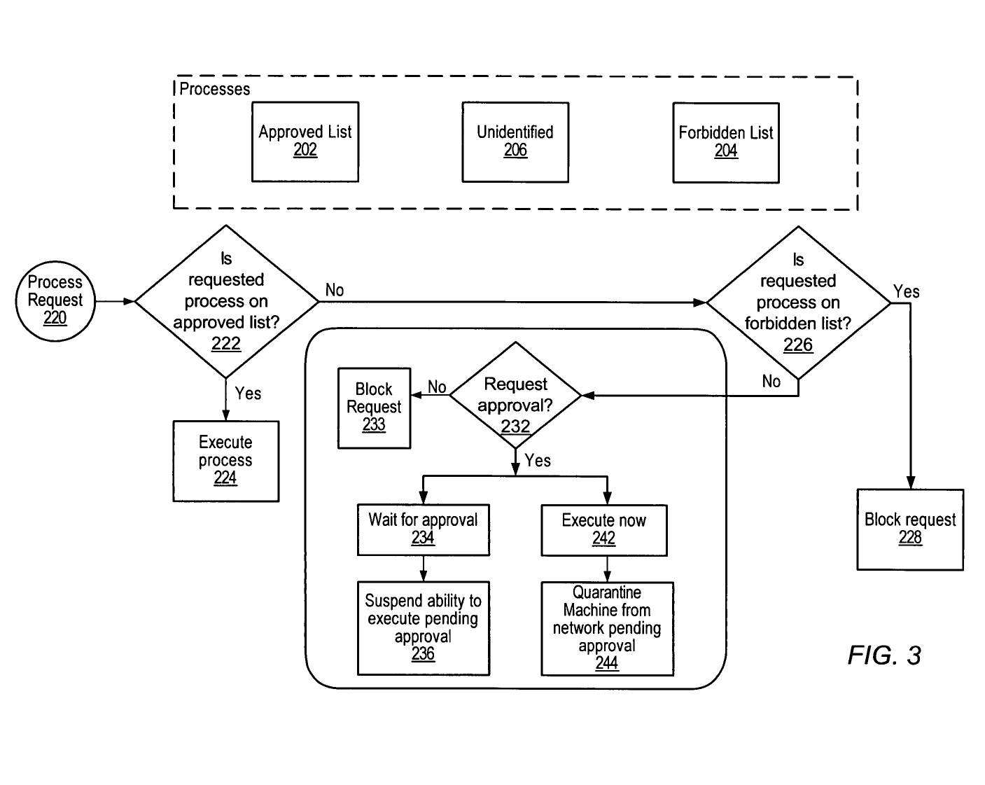

FIG. 3—High Level Diagram of the Protection Software Operation

FIG. 3 is a high level diagram illustrating operation of the protection software according to one embodiment of the invention. FIG. 3 illustrates how the protection software (Protection Agent) 200 protects a computer system, such as a desktop or server machine.

As shown, various process files may execute on each of the Protected Machines 120A-120F, these being process files that are in an Approved List 202, process files that are listed in a Forbidden List 204, and process files 206 that are unidentified, i.e., that are not in either of Approved List 202 or Forbidden List 204.

During normal execution of software in a Protected Machine 120 (a computer system executing a Protection Agent), various process requests will be made to the operating system to launch or invoke a process file in the computer system 120. For example, each time an application is invoked, one or more process requests will be made to the operating system.

When a process request occurs at 220, Protection Agent 200 may determine, at 222, if the requested process file is on the Approved List (the known-good list) 202. If the requested process file is on the Approved List 202, then the process file is allowed to execute at 224.

If the requested process is not on the Approved List 202, then Protection Agent 200 may determine, at 226, if the requested process file is on the Forbidden List (the known-bad list) 204. Forbidden list 204 may not be necessary to protect the enterprise since Approved list 202 is sufficient for ensuring bad things do not execute, but is provided to allow for a finer level of control over the enterprise. If the requested process file is on the Forbidden List 204, then in 228 the Protection Agent 200 may block the process request, and hence the process file is not allowed to execute within the Protected Machine 120. Thus, if the process file is on the Forbidden list, it is blocked from executing. The administrator can configure the system to log information about blocked process files and to have this information stored in a database (e.g., database 104) for reporting and/or auditing.

If the requested process file is not on either Approved List 202 or Forbidden List 204, then the requested process file is an “unidentified” process file 206. In this case, in one embodiment Protection Agent 200 may be configured to request approval from the protection software executing on TI Server 102, as shown at 232. Thus, if the process is Unidentified (not on the Approved or Forbidden list), Protection Agent 200 may determine if it should request approval for this process. If Protection Agent 200 is not configured to request approval for Unidentified (not on the Approved or Forbidden list), then the request may be blocked, as indicated at 233. If Protection Agent 200 is not configured to request approval for Unidentified (not on the Approved or Forbidden list) the administrator can configure the system to ask a currently logged on user if she/he wants to wait for the process file to be approved by an administrator. Also, the system can be configured to automatically request approval of unidentified processes. For instance, automatically requesting approval of unidentified processes may be performed when there is no currently logged on user.

If Protection Agent 200 is configured to request approval, then Protection Agent 200 can either wait for the approval (or denial) as indicated by 234, or the Protection Agent 200 can allow the requested resource to execute in a quarantined environment. Where the Protection Agent 200 waits for the approval (or denial), during this time the Protection Agent 200 suspends the ability of the requested process file to execute pending the approval (or denial), as indicated by 236.

Where Protection Agent 200 is configured to allow the requested process to execute in a quarantined environment as indicated by 232, then at 242 Protection Agent 200 enables the requested process file to execute, without waiting for any type of approval. As shown at 244, Protection Agent 200 may quarantine the Protected Machine 120 from the network and/or other resources, pending approval from the TI Server 102. When a process is execute in a quarantined environment, the process may not be given access to certain resources on the machine. The level of quarantine may be configurable and include such things as:

Network access;

Registry update access;

File write access (e.g., can be controlled by file extension);

File execute access;

Etc.

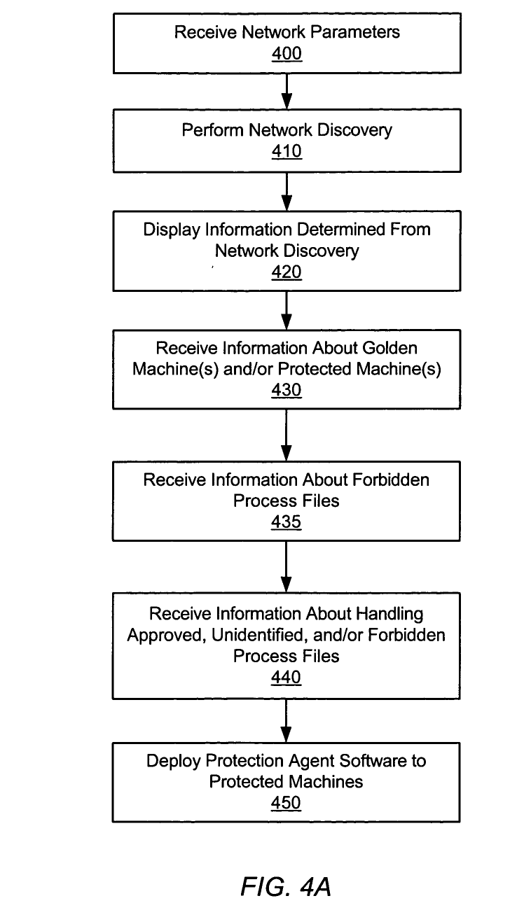

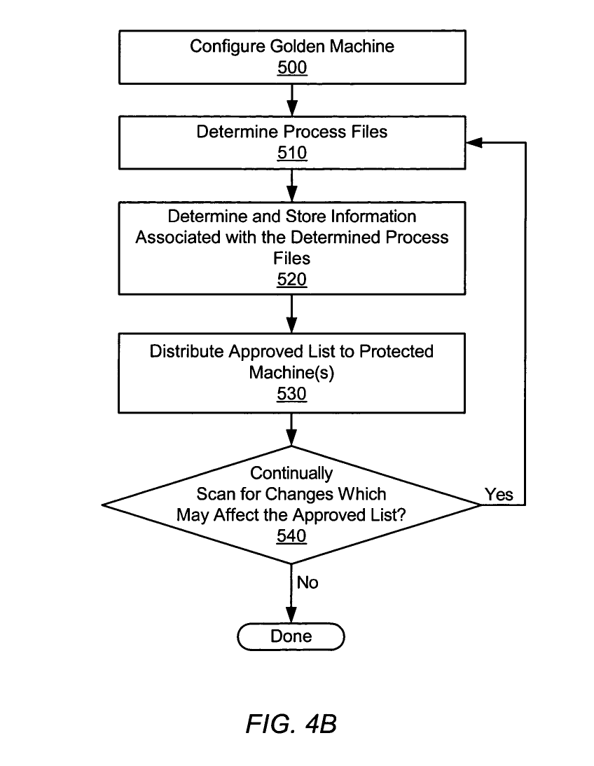

FIG. 4A—Configuration of an Enterprise

FIG. 4A is a flowchart diagram of a method for initializing an Enterprise protection software (e.g., TotalImmunity) installation, according to various embodiments. It is noted that in various embodiments one or more of the method elements may be performed concurrently, in a different order, or may be omitted. Additional method elements may also be performed as desired.

In some embodiments, the TotalImmunity Administrator may use a computer system such as admin console 106 for setting up or initializing the Enterprise protection software (TotalImmunity) installation. Admin console 106 and various other computer systems (e.g., TI server 102 and database 104, among others) may be used for initializing the Enterprise protection software (TotalImmunity) installation.

As indicated at 400, various network parameters may be received. For example, the TotalImmunity Administrator may specify one or more network parameters which may be used in a network discovery. For instance, the TotalImmunity Administrator may specify one or more of an operating system, a network address range (e.g., 192.168.1.0 to 192.168.3.255), a subnet (e.g., 192.168.6.0/24), a logical domain (e.g., corporate.somecompany.com), an active directory domain, and an NT domain, among others. In some embodiments, the TotalImmunity administrator may define one or more exclusions which may exclude some computer systems from a network discovery and prevent them from being included in the enterprise configuration. For example, the exclusions may be defined as one or more of: an operating system, a network address (e.g., 192.168.10.1), a logical name (e.g., somecomputer.corporate.somecompany.com), a network address range, a subnet, a logical domain, an active directory domain, and an NT domain, among others.

At 410, TI Server 102 may perform a network discovery based on the network parameters received at 400. The network discovery may determine a list of computer systems such as computer systems 112A-112C and/or 120A-120F, among others. In some embodiments, TI Server 102 may perform the network discovery.

As indicated at 420, information determined by the network discovery may be displayed to the TotalImmunity Administrator. For example, the determined list of computer systems may be displayed in a graphical user interface (GUI). The TotalImmunity Administrator may graphically manipulate the displayed list of determined computer systems to make selections and/or modifications to an enterprise configuration. For example, if the enterprise configuration is displayed graphically or iconically, the TotalImmunity Administrator may use various drag and drop techniques, cut-and-paste techniques, check-box techniques, or other graphical editing techniques to select and/or modify the enterprise configuration, as desired. In some embodiments, a web service interface may be provided as a graphical user interface to the administrator.

At 430, information which may select and/or modify the enterprise configuration may be received. For example, the TotalImmunity Administrator may actuate a “Commit” and/or “Create” button on the graphical user interface which may indicate the TotalImmunity Administrator has selected one or more computer systems to be Golden Machines and/or one or more computer systems to be Protected Machines. For instance, computer systems 112A-112C may be selected as Golden Machines and/or computer systems 120A-120F may be selected as Protected Machines. The Golden Machines may be used as the source for the Approved List of process files for the enterprise configuration. Various graphical or other user input methods may be used.

At 435, information may optionally be received regarding one or more forbidden process files. In one example, information may be received from a non-volatile memory medium provided by the provider of the Protection Agent software. In a second example, information may be received from subscription service 130 which specifies one or more forbidden process files. In a third example, information may be received through the graphical user interface where the TotalImmunity Administrator may specify one or more forbidden process files. Information regarding forbidden process files may be received using one or more of the above methods and/or other methods.

At 440, information about handling approved process files, unidentified process files, and/or forbidden process files may be received. For example, a configuration regarding logging usages of approved process files, logging blocking of forbidden process files, and/or logging of unidentified process files may be received, among other configuration information.

As indicated at 450, Protection Agent software may be deployed to one or more Protected Machines 120A-120F. The Protection Agent software may be distributed to the one or more Protected Machines 120A-120F in various ways. In one example, the Protection Agent software may be distributed to the one or more Protected Machines 120A-120F via a non-volatile storage medium (e.g., a disk or CD-ROM, among others). In a second example, TI server 102 may install the Protection Agent software, e.g., Protection Agent 200, by “pushing” the Protection Agent software to the one or more Protected Machines 120A-120F through a network. As used herein, the terms “push”, “pushed”, and “pushing” may be associated with a first computer system providing information (e.g., one or more files, Approved Lists, Forbidden Lists, software programs, dynamic libraries, shared libraries, etc.) to a second computer system without the second computer system necessarily specifying and/or requesting the information. In some embodiments, the first computer system and the second computer system may be included in a hierarchical system where the first computer system is “trusted” (e.g., may have an access level, permission, etc. to install files, software, etc.) by the second computer system. In some embodiments, the Protection Agent software may be included into an install package for distribution to the one or more Protected Machines 120A-120F. For instance, a package distribution tool or mechanism may be used to distribute and/or install the install package on the one or more Protected Machines 120A-120F. Various package distribution and/or installation tools may include ZenWorks, SMS, and Tivoli, among others. In some embodiments, an administrator may configure one or more logon scripts in an AD or NT domain to install Protection Agent software when users log into the machines to be protected.

FIG. 4B—Creation and Management of an Approved List

FIG. 4B is a flowchart diagram of a method for creating and managing the Approved List, according to various embodiments. It is noted that in various embodiments one or more of the method elements may be performed concurrently, in a different order, or may be omitted. Additional method elements may be performed as desired. The method shown in FIG. 4C relates to using a Golden Machine to determine Approved process files. This method may be used in an enterprise or by a software vendor.

As indicated at 500, a Golden Machine 112A may be configured. In some embodiments, configuring Golden Machine 112A may include installing software such as an operating system, a Golden Machine Software Agent, application software, an upgrade to an operating system, an upgrade to application software, and/or one or more dynamically linked libraries and/or shared libraries, among others. Configuring Golden Machine 112A may include accessing new non-volatile storage (e.g., a hard drive, a floppy disk, a RAID, a CD-ROM, and/or network storage such as a network drive and/or a storage area network (SAN), among others). In 500 the Golden Machine 112A may be configured with a software configuration that is desired to be used on one or more computers (Protected Machines 120) in the enterprise. As discussed above, the Golden Machine 112A is preferably managed in a way to prevent unwanted software from being loaded. In one embodiment, a plurality of Golden Machines 112 are configured with the same software configuration.

At 510, one or more process files available to Golden Machine 112A may be determined. In some embodiments, determining the one or more process files available may include scanning non-volatile memory available to Golden Machine 112A. For example, hard drives and/or file systems of Golden Machine 112A and/or network storage available to Golden Machine 112A may be scanned.

At 520, information associated with the determined one or more process files may be determined and stored. For example, the Golden Machine Agent software may scan for process files, calculate various TotalImmunity Identifications for each process file and provide determined information associated with each process file to TI Server 102. In various embodiments, the Golden Machine Agent software may be implemented as an NT Service.

In some embodiments, determining process file identification information may include determining one or more of a hash value, a name of file, and a size of a file, among others. For example, the hash value may be a hash value from input from one or more of contents of a file, a name of the file, and a size of the file, among others. The determined process file identification information may be stored in an Approved List. For example, Golden Machine 112A may send the determined process file identification information to TI Server 102, where TI Server 102 may store the determined process file identification information in database 104.

In various embodiments, a new Approved List may be created. In some embodiments, a current Approved List may be updated. For instance, software which is already installed on Golden Machine 112A may have been updated with a newer version, and the current Approved List may be updated to indicate process files from the updated software. In another instance, software which was previously available to Golden Machine 112A may no longer be available to (e.g., may have been removed) Golden Machine 112A, and the current Approved List may be updated to remove an indication of the process files associated with software which was previously available to Golden Machine 112A. In yet another instance, software may be installed on Golden Machine 112A and/or be newly available to Golden Machine 112A (e.g., through network storage), and the current Approved List may be updated to indicate the process files from the newly installed and/or newly available software.

In some embodiments, one or more of the determined process files may be approved by an administrator before updating the Approved List. In various embodiments, one or more of the determined process files may be automatically approved (e.g., without user or administrator approval) which may be in accordance to one or more criteria. For example, various of the determined process files may be compared to Approved Lists of process files provided by one or more software vendors, and process files may be automatically approved if present on the Approved List of a software vendor.

In one embodiment, the Approved List may be populated with process files determined from the one or more Golden Machines 112, and approved process files received from one or more respective software vendors. For example, Microsoft may provide a list of approved process files for its WINDOWS™ operating system and OFFICE™ software. These approved process files may be placed on the Approved List (or used to update the Approved List), in addition to process files determined from the one or more Golden Machines 112

At 530, the Approved List may be distributed to one or more Protected Machines 120A-120F. In some embodiments, the Protection Agent software and the Approved List may be automatically distributed (e.g., without user or administrator approval) to one or more Protected Machines 120A-120F. In various embodiments, an administrator may manually select one or more Protected Machines 120A-120F and distribute the Approved List to the selected Protected Machines.

The Approved List may be distributed to the one or more Protected Machines 120A-120F in various ways. In one example, the Protection Agent software may be distributed to the one or more Protected Machines 120A-120F via a non-volatile storage medium (e.g., a disk or CD-ROM, among others). In a second example, TI server 102 may install the Approved List by “pushing” the Approved List to the one or more Protected Machines 120A-120F over the network. In some embodiments, the Approved List may be incorporated into an install package for distribution to the one or more Protected Machines 120A-120F. For instance, a package distribution tool or mechanism may be used to distribute and/or install the install package on the one or more Protected Machines 120A-120F. Various package distribution and/or installation tools may include ZenWorks, SMS, and Tivoli, among others. In some embodiments, an administrator may configure one or more logon scripts in an AD or NT domain to install the Approved List when users log into the machines to be protected.

In some embodiments, Golden Machine 112A may be configured to continually scan for changes which may affect the Approved List. For example, a file system filter driver may be included with the Golden Machine Agent software which may watch for one or more installations of new process files after the initial scan in order to report new process files to TI Server 102. As indicated at 540, if Golden machine 112A is configured to scan for changes which may affect the Approved List, then the method may proceed to 510. In some embodiments, various reports may be generated which indicate updates, creation, and/or changes to one or more Approved Lists. These reports may be automatically distributed (e.g., emailed) to one or more administrators on a schedule and/or on an event driven basis.

In various embodiments, the process files determined in the method illustrated in FIG. 4B may be available to create and/or update a portion of the Approved List. For example, Golden Machine 112A may include database software (e.g., Oracle, PostGres, MySQL, SQLServer, etc.), and the determined process files may be associated with the database software (e.g., server and/or client, among others). These process files may be added to and/or supplement an existing Approved List. This addition and/or supplement may be distributed to all Protected Machines 120A-120F or to a portion of the Protected Machines 120A-120F. For instance, the determined process files associated with the database software may only be distributed to a portion of the Protected Machines 120A-120F which may execute database software.

In another example, an Approved List may be provided by a provider of the Protection software and/or a subscription service. For instance, the Approved list from the provider of the Protection software may comprise some or all of the process files included in the operating system which is installed on Golden Machine 112A. Scanning for process files may comprise scanning for process files other than the process files included in the operating system, and these other process files may be included in a new Approved List or a portion of an existing Approved list.

After the Approved list is determined and the Approved List and Protection Agent software are distributed to one or more Protected Machines 120A-120F, the Protection software may protect the one or more Protected Machines 120A-120F (e.g., desktop and/or server machines in the enterprise). When the Protection software is protecting an enterprise configuration, the administrator may only be required to perform a few tasks, since most of the system operation may be automated. Administrator tasks may comprise viewing reports and authorizing user requests for unidentified processes, among others.

Various Configurations

In various embodiments, the administrator may configure the Protection software to work with various environments and/or situations. A configuration may be defined as Global and used as the defaults for all machines in the enterprise and may be overridden by a Collection configuration which may only apply to a specific set of machines within one or more Collections. The following configuration values may be specified by the administrator:

What should the protection software do when an Approved process file is executed?
(i) Log the process request as Approved-Run and send this log entry to TI Server 102 for audit reporting; or
(ii) Do not log the process request.

What should the protection software do when a Forbidden process file request is received?
(a) Allow it to be executed (this may be useful when executing the protection software in a test mode to determine how the protection software would perform in an environment without actually blocking execution);
   (i) Log the process request as Forbidden-Run and send this log entry to TI Server 102 for audit reporting; or
   (ii) Do not log the process request;
(b) Block the process from executing and if there is a logged on user, display a message to the user indicating the process file cannot be executed (the TotalImmunity administrator may specify the message that is displayed);
   (i) Log the process request as Forbidden-Block and send this log entry to TI Server 102 for audit reporting;
   (ii) Do not log the process request;
   (iii) If there is a logged on user, display a message to the user (the administrator can specify the message that is displayed) that allows the process file to execute only if the user provides a valid key (keys may be generated from the central server for user's with proper rights);
      a) Log the process request as Forbidden-RunKey if the user enters a valid key and executes the process file or as Forbidden-BlockKey if the user does not execute the process file and transmit this log entry to TI Server 102 for audit reporting; or
      b) Do not log the process request;
   and/or (c) If there is no logged on user, allow the forbidden process file to execute, but execute the forbidden process file in Quarantine mode;
      (i) Log the process request as Forbidden-RunQuarantine and send this log entry to TI Server 102 for audit reporting; or
      (ii) Do not log the process request.

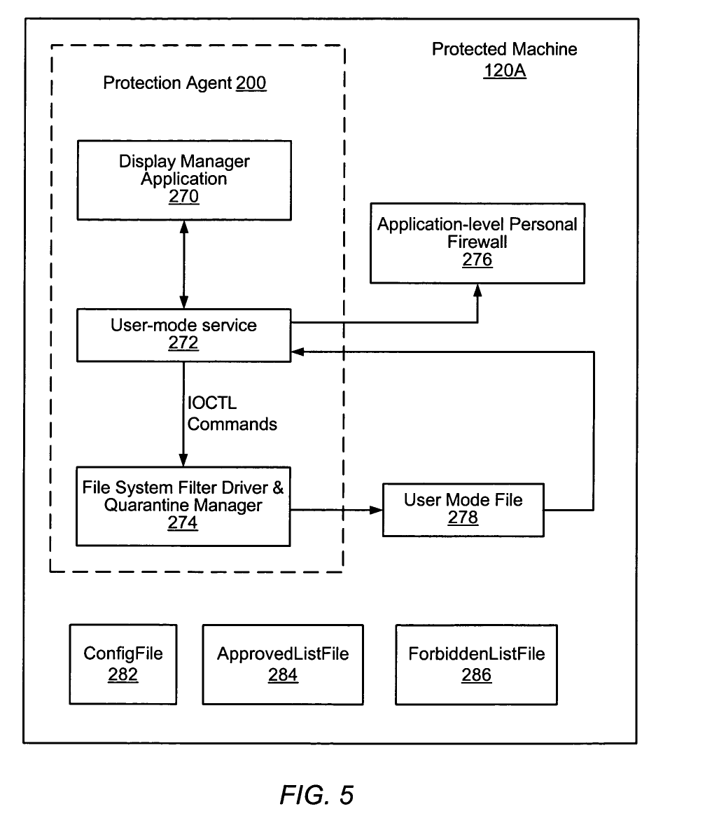

What should a Protected Machine do when an Unidentified process file request is received?
(a) Allow it to be executed (this may be useful when executing the protection software in a test mode to determine how the protection software would perform in an environment without actually blocking execution);
   (i) Log the process request as Unidentified-Run and send this log entry to TI Server 102 for audit reporting; or
   (ii) Do not log the process request;
(b) Allow it to be executed, but in Quarantine mode;
   (i) Log the process request as Unidentified-RunQuarantine and send this log entry to TI Server 102 for audit reporting; or
   (ii) Do not log the process request;
(c) Block the process from excuting;
   (i) If there is a logged on user, display a message to the user indicating the process cannot be executed (the TotalImmunity administrator may specify the message that is displayed);
   (ii) Log the process request as Unidentified-Block and send this log entry to TI Server 102 for audit reporting; or
   (iii) Do not log the process request;
(d) If there is a logged on user, display a message to the user (the TotalImmunity administrator may specify the message that is displayed) that allows the process to executed only if the user provides a valid key (keys are generated from the central server for user's with proper rights).
   (i) Log the process request as Unidentified-RunKey if the user enters a valid key and executes the process or as Unidentified-BlockKey if the user does not execute the process and send this log entry to TI Server 102 for audit reporting; or
   (ii) Do not log the process request;
(e) If there is a logged on user, display a message to the user (the TotalImmunity administrator may specify the message that is displayed) that allows the process file to execute, but in Quarantine mode, only if the user provides a valid key (keys may be generated from a central server, e.g., TI Server 102, for user's with proper rights).
   (i) Log the process request as Unidentified-RunKeyQuarantine if the user enters a valid key and executes the process file or as Unidentified-BlockKey and if the user does not execute the process file and send this log entry to TI Server 102 for audit reporting; or
   (ii) Do not log the process request;
(f) Request approval for the unidentified process;
   (i) If there is a logged on user, display a message to the user indicating the process is unidentified and request approval (the TotalImmunity administrator may specify the message that is displayed);
   (ii) Allow the user to provide a key to execute the process file without approval;
   (iii) Run the process in Quarantine mode if key is used;
   (iv) Log the approval request indicating the action taken and send this log entry to TI Server 102 for audit reporting. The log entry may comprise one of Unrecognized-Run, Unrecognized-Block, Unrecognized-RunKey, Unrecognized-BlockKey, and Unrecognized-RunKeyQuarantine; or
   (v) Do not log the process request;
and/or (g) If there is no logged on user, automatically request approval for the unidentified process and wait for the approval to run the process;
   (i) Log the approval request as Unrecognized-RunAuto or Unrecognized-BlockAuto (based on the results of the approval request) and send this log entry to TI Server 102 for audit reporting; or
   (ii) Do not log the process request.
      FIG. 5—Components of a TotalImmunity Protected Machine

FIG. 5 illustrates an exemplary block diagram of various components of Protected Machine 120A. It is noted that the examples provided in FIG. 5 are meant to be exemplary only and are not meant to limit any embodiments to any particular content(s) and/or format(s). It is also noted that in various embodiments one or more of the components may execute concurrently, in various orders, or may be omitted. In the embodiment shown, Protected Machine 120A may comprise a Protection Agent 200, an Application Personal Firewall (APF) 276, and a User Mode File (UMF) 278. In various embodiments, Protection Agent 200 may comprise a Display Manager Application (DMA) 270, a User-mode service (UMS) 272, and a File System Filter Driver and Quarantine Manager (FSFDQM) 274.

In some embodiments, DMA 270 may be responsible for user interaction (e.g., displaying dialogs, accepting user input in response to dialogs, etc.). DMA 270 may execute from a run key in a registry when a user logs on and may cease execution when the user logs off. The user interaction may be handled by DMA 270 (as opposed to a user-mode service) so that various high-privileged user-mode services are not exposed to the user and allow the system to determine when the user has logged on and logged off. Further, DMA 270 may allow the system to request and/or receive user-input.

In various embodiments, UMS 272 may communicate with TI server 102 and may coordinate activities between DMA 270 and FSFDQM 274. UMS 272 may provide interaction with APF 276 which may implement various process quarantining.

In some embodiments, FSFDQM 274 may be a device driver which is comprised by kernel software and/or used by kernel software, and FSFDQM 274 may capture various process file requests. For example, a request for a process file may be captured by FSFDQM 274, and FSFDQM 274 may determine if the process file may be executed. In various embodiments, FSFDQM 274 may implement file-level and/or registry-level process quarantine support. For example, FSFDQM 274 may provide registry-level quarantine support by intercepting various system-level registry requests for one or more quarantined processes and determine whether or not these requests are allowed or denied.

In various embodiments, APF 276 may provide various quarantine support for quarantining one or more processes, and APF 276 may be separate from FSFDQM 274. For example, APF 276 may comprise a network filter driver which may not be comprised in a file system filter device driver such as FSFDQM 274. Separating APF 276 from FSFDQM 274 may provide various benefits. For instance, APF 276 may be supplied separately (e.g., by a “third-party” firewall product) from FSFDQM 274 which may allow APF 276 to be upgraded and/or changed without upgrading and/or changing Protection Agent 200 and/or FSFDQM 274.

In some embodiments, FSFDQM 274 may communicate with UMS 272 by writing various entries to UMF 278. For instance, because FSFDQM 274 writes entries to UMF 278, operations may be inherently asynchronous. For example, if UMS 272 is not running or is handling other requests, FSFDQM 274 may still be able to queue up a communication request to UMS 272 to be handled when UMS 272 has started or is available to handle requests from FSFDQM 274. This may help overcome communications issued during system boot in which FSFDQM 274 may be running, but UMS 272 has not yet been started.

In various embodiments, entries comprised in UMF 278 may include one or more of a TotalImmunity Identification, a status, a logged on user if any, and a unique ID assigned by FSFDQM 274. As noted above, the TotalImmunity Identification may include a name of a process file, a size of the process file, and a hash value of contents of the process file. The status may indicate to UMS 272 an action to be performed. For example, UMS 272 may display an informational dialog and/or receive user input (e.g., a key to override the process-request block) in response to the action indicated by the status. In some embodiments, when FSFDQM 274 queues a message to UMS 272 via UMF 278, it may assign a unique ID to the message. UMS 272 may respond to these messages, if needed, by generating an input/output control (IOCTL) command or message that compries the unique ID. This may allow FSFDQM 274 to pair any requests with a correct response so that a pending information request packet (IRP) can be processed when the response is received. In various embodiments, FSFDQM 274 may support one or more IOCTL commands: “Allow Process Request”, “Deny Process Request”, “File Approved”, “Add To Approved List”, “Remove From Approved List”, “Add To Forbidden List”, and “Remove From Forbidden List”, among others.

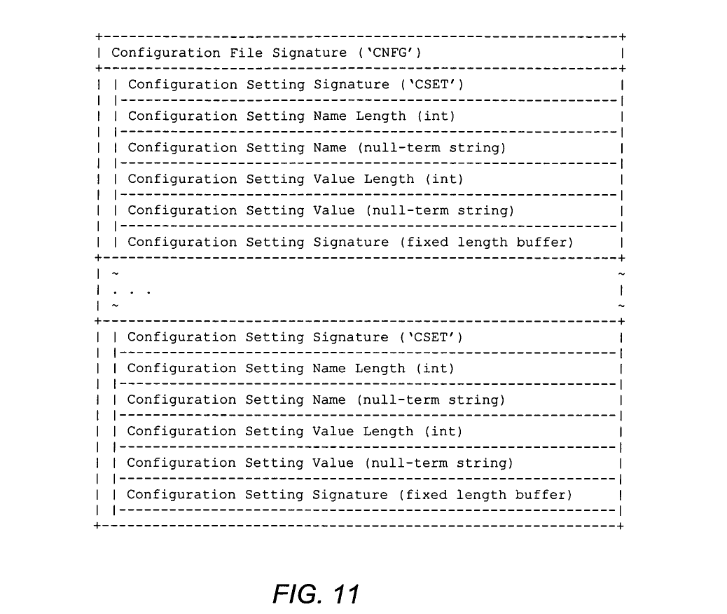

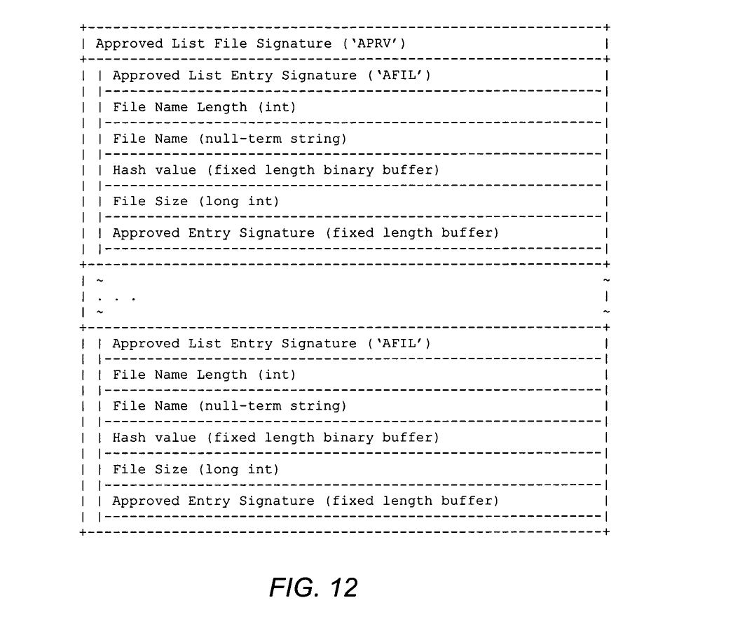

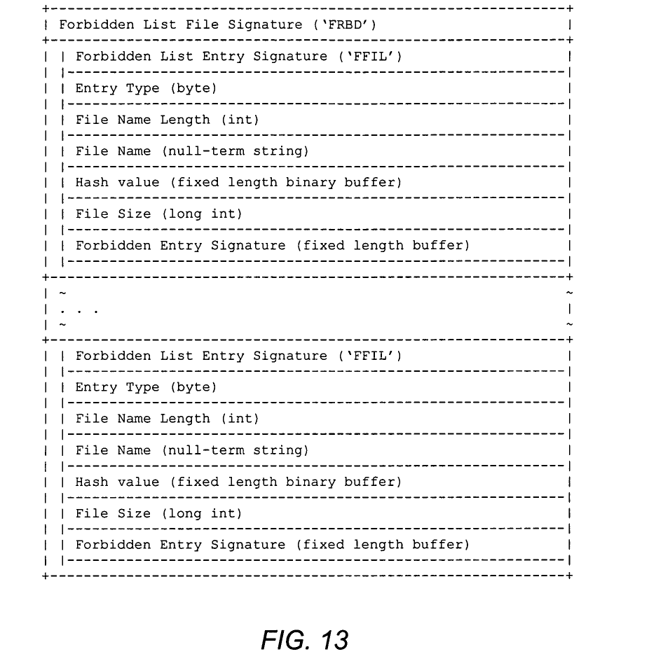

In some embodiments, Protected Machine may comprise ConfigFile 282, ApprovedListFile 284, and ForbiddentListFile 286. Exemplary instances ConfigFile 282, ApprovedListFile 284, and ForbiddentListFile 286 are illustrated in FIGS. 11-13, respectively, and described further below.

ConfigFile 282 may comprise various settings which indicate how Protection Agent 200 performs. The settings may be set by an administrator and each setting entry in ConfigFile 282 may be digitally signed by TI server 102 using its private key which may provide a level of integrity for the settings of ConfigFile 282. ApprovedListFile 284 may comprise a list of various processes (process files) which may be executed on Protected Machine 120A (the Approved List). ForbiddentListFile 286 may comprise a list of various process files which may not be executed on Protected Machine 120A (the Forbidden List).

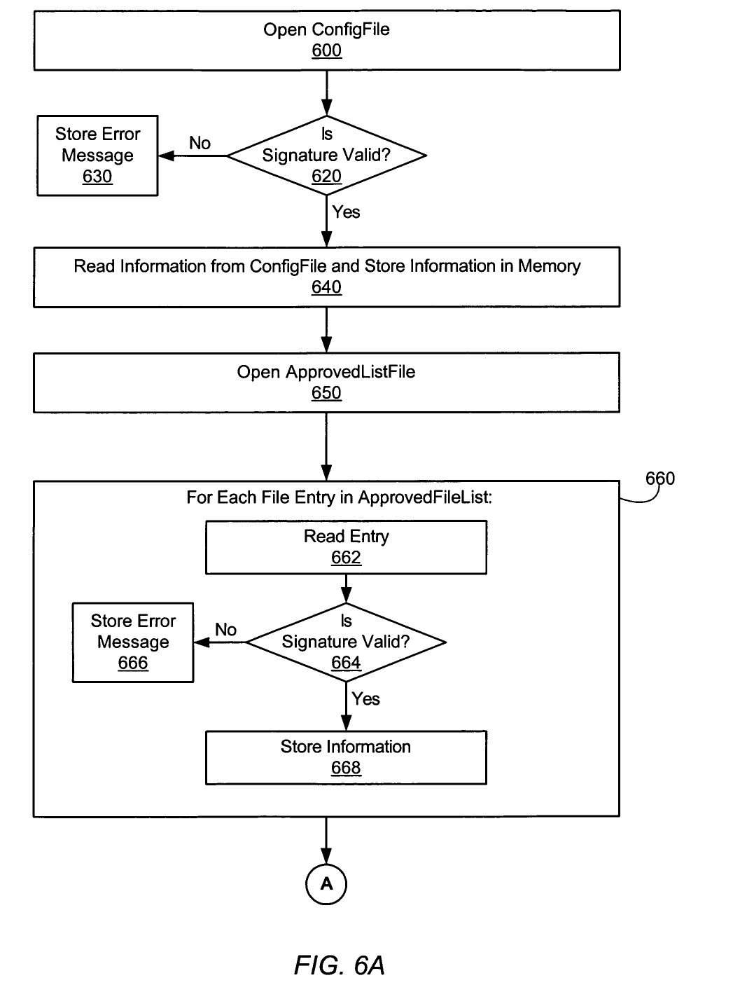

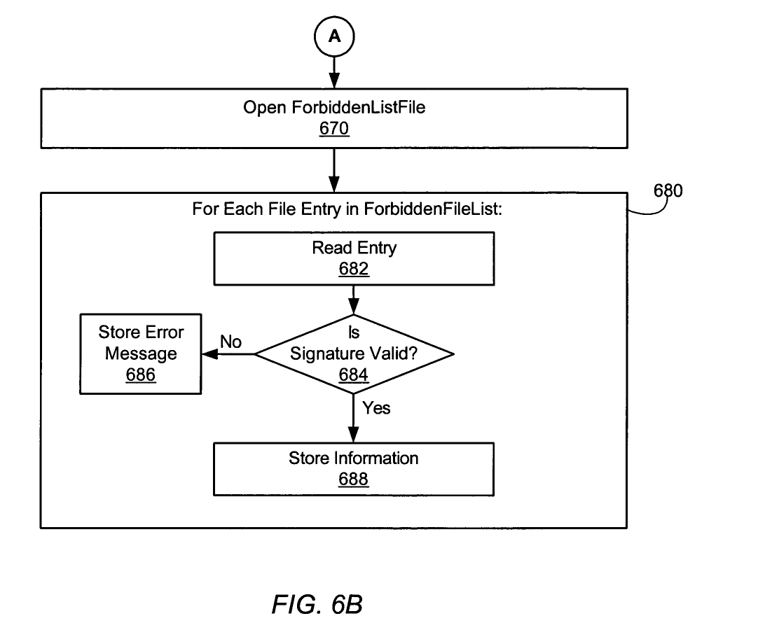

FIGS. 6A-6B—FSFDQM Initialization

FIGS. 6A-6B illustrate a flowchart diagram of a method for initializing FSFDQM 274, according to various embodiments. It is noted that in various embodiments one or more of the method elements may be performed concurrently, in a different order, or may be omitted. Additional method elements may be performed as desired.

As indicated at 600, ConfigFile 282 may be opened. For example, ConfigFile 282 may be opened such that information may be read from it. In some embodiments, ConfigFile 282 may have a digital signature associated with it. For example, the digital signature which may be associated with ConfigFile 282 may be generated by one or more of TI Server 102 and/or Subscription Service 130, among others. At 620, it may be determined whether or not the digital signature is valid.

If the digital signature is not valid an error message may be stored as indicated at 630. For example, the error message may be logged locally and/or logged to TI Server 102. If the digital signature is valid, information may be read from ConfigFile 282 and stored in memory, at 640. In some embodiments, ConfigFile 282 may comprise various settings. For example, a setting may include a name and a value. For instance, one or more settings which may be read from ConfigFile 282 may include information associated with ApprovedListFile 284. The information associated with ApprovedListFile 284 may, for example, include location information regarding ApprovedListFile 284 (e.g., a location where ApprovedListFile 284 may be stored). The settings may also include digital signature information which may be usable to validate the setting.

At 650, ApprovedListFile 284 may be opened. For example, ApprovedListFile 284 may be opened such that information may be read from it. ApprovedListFile 284 may comprise a list of various processes which may be executed. In some embodiments, the list may comprise one or more entries, and the one or more entries may each comprise process file identification information (e.g., a TotalImmunity Identification, a hash value, a file name, etc.) and digital signature information which may be used to validate the entry.

As indicated at 660, 662-668 may be performed for each entry in ApprovedListFile 284. At 662, the entry may be read. At 664, it may be determined whether or not the digital signature information is valid. If the digital signature information is not valid, an error message may be stored as indicated at 666. For example, the error message may be logged locally and/or logged to TI Server 102. If the digital signature information is valid, the process file identification information (e.g., a TotalImmunity Identification, a hash value, a file name, etc.) may be stored in memory at 668. For example, the process file identification information may be stored in a hash table, among other data structures, which is associated with a list of approved process files. A hash table, among other data structures, may be used to provide “quick” lookup capabilities to Protection Agent 200 and/or FSFDQM 274, where the term “quick” means fast according to some metric. In some embodiments, a hash value may be used to index into the hash table to determine if the hash value and possible corresponding information is present.

At 670 (FIG. 6B), ForbiddentListFile 286 may be opened. For example, ForbiddentListFile 286 may be opened such that information may be read from it. In various embodiments, ForbiddentListFile 286 may comprise a list of various processes which may not be executed. In some embodiments, the list may comprise one or more entries, and the one or more entries may each comprise identification information (e.g., a TotalImmunity Identification, a hash value, a file name, etc.) and digital signature information which may be used to validate the entry. For example, the process file identification information may be stored in a hash table, among other data structures, which is associated with a list of forbidden process files.

As indicated at 680, 682-688 may be performed for each entry in ForbiddentListFile 286. At 682, the entry may be read. At 684, it may be determined whether or not the digital signature is valid. If the digital signature is not valid an error message may be stored as indicated at 686. For example, the error message may be logged locally and/or logged to TI Server 102. If the digital signature information is valid, the process file identification information (e.g., a TotalImmunity Identification, a hash value, a file name, etc.) may be stored in memory. For example, the process file identification information may be stored in a hash table, among other data structures, which is associated with a list of forbidden process files.

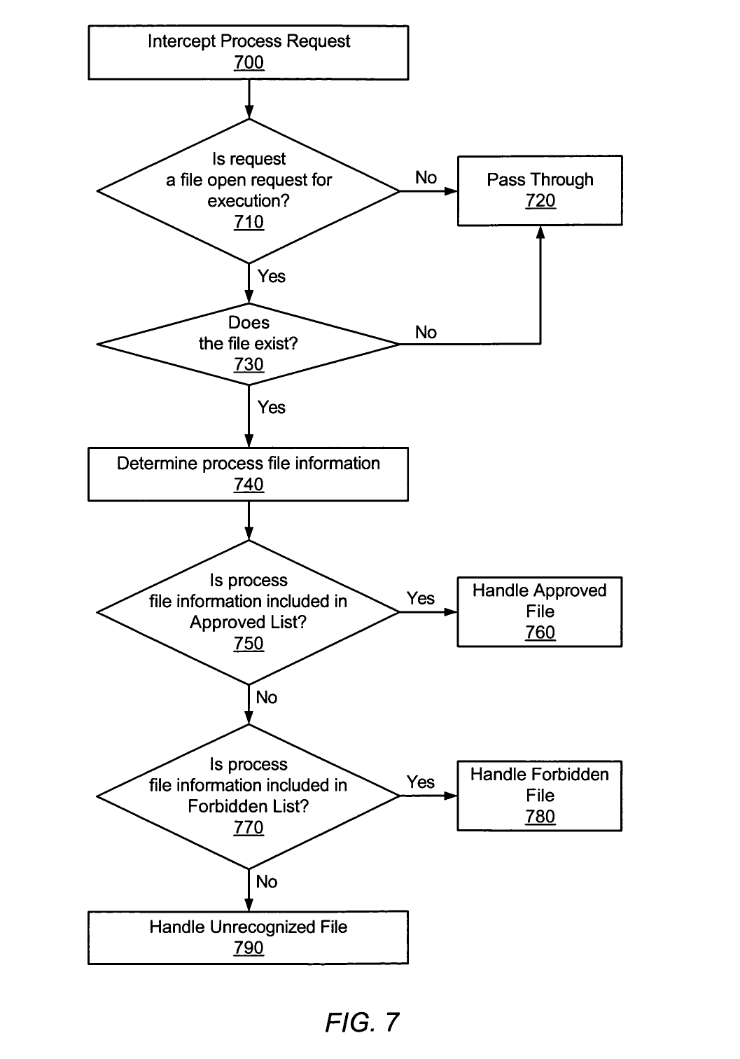

FIG. 7—Intercept and Handle Process Request

FIG. 7 illustrate a flowchart diagram of a method for intercepting (receiving) and handling a process request, according to various embodiments. It is noted that in various embodiments one or more of the method elements may be performed concurrently, in a different order, or may be omitted. Additional method elements may be performed as desired.

As indicated at 700, a process request may be intercepted (received). In some embodiments, Protection Agent 200 and/or FSFDQM 274 may intercept commands that request opening of files. For example, Protection Agent 200 and/or FSFDQM 274 may intercept requests in a create dispatch function.

At 710, it may be determined whether or not the request is a command to open a file for execution. If the request not is a command to open the file for execution, the method may pass the request through to an appropriate routine which handles the request at 720. If the request is a command to open the file for execution, it may be determined whether or not the file exists at 730. If the file does not exist, the method may pass the request through to an appropriate routine which handles the request at 720. If the file does exist, process file information may be determined at 740.

In some embodiments, determining process file information may include determining a hash value associated with the file. For example, the hash value associated with the file may be based on one or more of contents of the file, a size of the file, a name of the file, among others. In some embodiments, determining process file information may include forming a TotalImmunity Identification using the file name (or a portion of the filename) along with the size of the process file and hash value from the process file contents. This information may be compared against one or more TotalImmunity Identification entries comprised in the Approved List.

At 750, it may be determined whether or not the determined process file information is included in the Approved List. In some embodiments, determining if the process file is on the Approved List may include using the TotalImmunity Identification formed at 740 and comparing it to various entries of the Approved List. In various embodiments, determining if the process file is on the Approved List may include using the TotalImmunity Identification formed at 740 and using that to index into the Approved List to determine if the process file is on the Approved List. If a match is found, then the file being opened is on the Approved list. If a match is not found, then the file is not on the Approved list.

If the determined process file information is included in the Approved List, the request may be handled at 760. If the determined process file information is not included in the Approved List, it may be determined whether or not the process file information is included in the Forbidden List. In some embodiments, determining whether or not a process file is comprised in the Forbidden List may be more flexible. For example, control may be given to process-requests which may be desired to forbid. The Forbidden List may comprise one or more of: (a) file names that are desired to forbid, regardless of their contents; (b) hash values of file contents and file sizes that are desired to forbid, regardless of a file name; and (c) TotalImmunity Identifications that are desired to forbid. In determining if a process file is comprised in the Forbidden List may include one or more of determining a match on the Forbidden List which may correspond to one or more of (a)-(c).

If the process file information is included in the Forbidden List, the request may be handled at 780. If the process file information is not included in the Forbidden List, the process file may be considered to be unrecognized and be handled at 790.

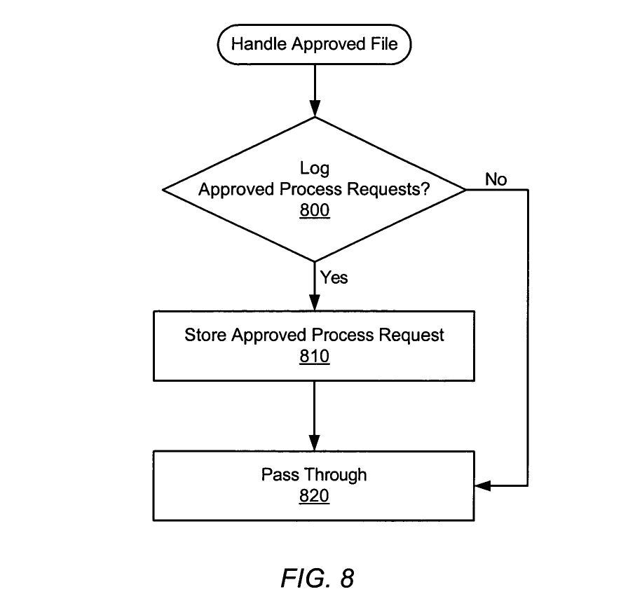

FIG. 8—Intercept and Handle Process Request

FIG. 8 illustrates a flowchart diagram of a method for handling a request to execute a process file which is comprised in the Approved List, according to various embodiments. It is noted that in various embodiments one or more of the method elements may be performed concurrently, in a different order, or may be omitted. Additional method elements may be performed as desired.

In various embodiments, method elements 800-820 may be performed with reference to 720 of FIG. 7. At 800, it may be determined whether or not execution of the approved process file is logged. For example, information comprised in ConfigFile 282 may indicate whether or not execution of the approved process file is logged. If execution of the approved process file is not logged, the request may be passed through to an appropriate routine which handles the request at 820. If execution of the approved process file is logged, information regarding execution of the approved process file may be stored at 810, and then the request may be passed through to an appropriate routine which handles the request at 820.

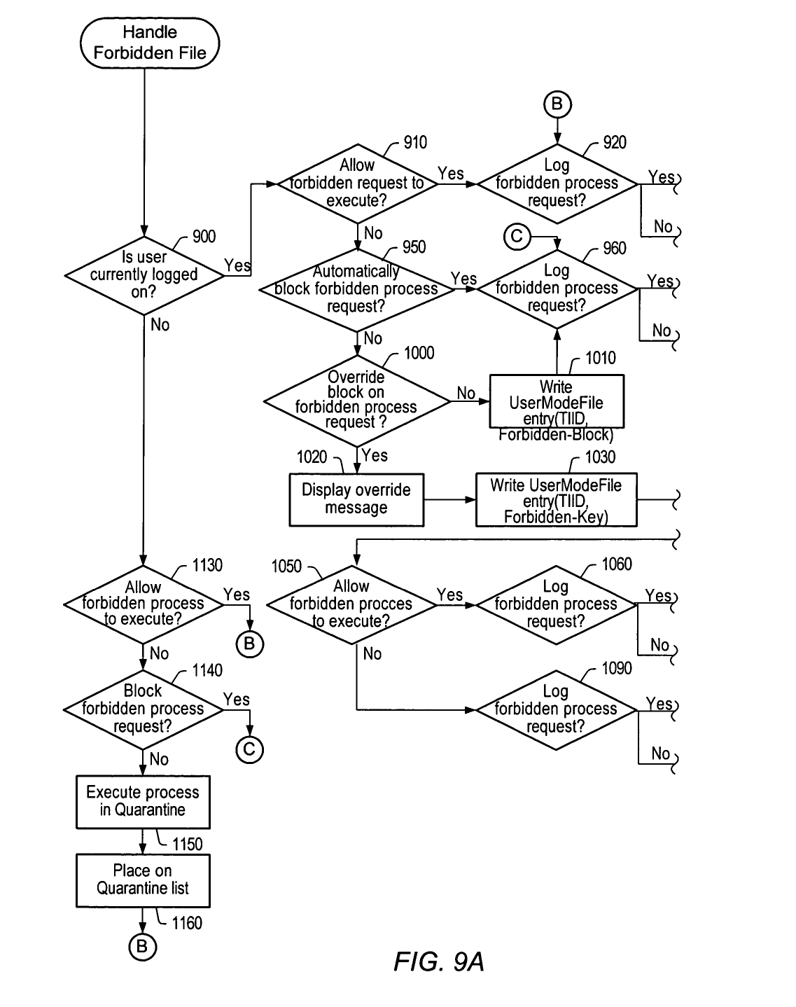

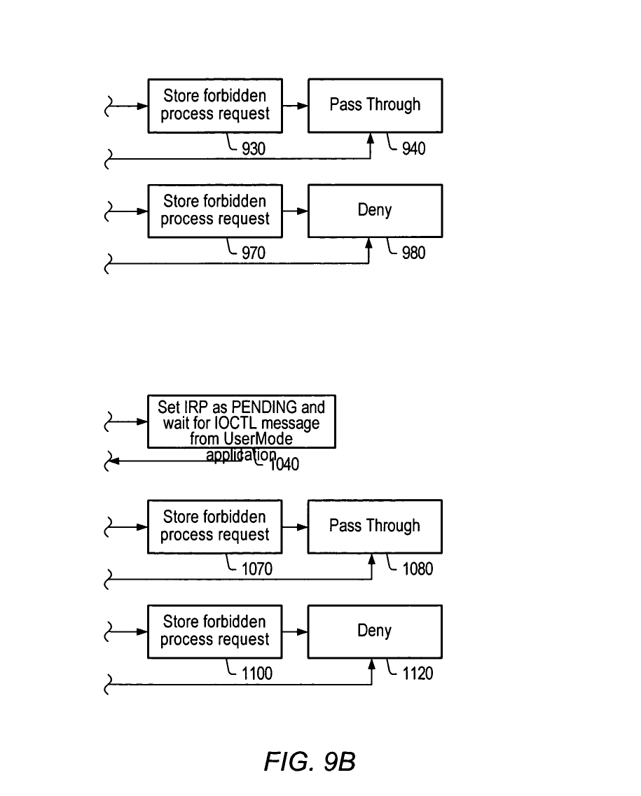

FIGS. 9A-9B—Handle Forbidden Process Request

FIGS. 9A-9B illustrate a flowchart diagram of a method for handling a request to execute a process file which is comprised in the Forbidden List, according to various embodiments. It is noted that in various embodiments one or more of the method elements may be performed concurrently, in a different order, or may be omitted. Additional method elements may be performed as desired.

In various embodiments, method elements 900-1200 may be performed with reference to 780 of FIG. 7. At 900, it may be determined if a user is currently logged in to the computer system where the request to execute the forbidden process file occurs. If the user is currently logged in, it may be determined if the request to execute the forbidden process file is allowed at 910. If the request to execute the forbidden process file is allowed, it may be determined if the forbidden process request is to be logged at 920. If the forbidden process request is to be logged, information associated with the forbidden process request may be stored in UMF 278 at 930. For instance, information associated with the forbidden process request may comprise a TotalImmunity Identification and Forbidden-Run status. The forbidden process request may be passed through to be executed at 940. If the forbidden process request is not to be logged, forbidden process request may be passed through to be executed at 940.

If the request to execute the forbidden process file is not allowed, it may be determined if the forbidden process request is to be automatically blocked at 950. If the forbidden process request is be blocked, it may be determined if the forbidden process request is to be logged at 960. If the forbidden process request is to be logged, information associated with the blocked process request may be stored in UMF 278 at 970. For instance, information associated with the forbidden process request may comprise a TotalImmunity Identification and Forbidden-Block status. The forbidden process request may be denied at 980. If the forbidden process request is not to be logged, the forbidden process request may be denied at 980.

If the forbidden process request is not to be automatically blocked, it may be determined if the blocked request to the forbidden process file may be overridden at 1000. If the blocked request to the forbidden process file may not be overridden, an entry may be stored in UMF 278 which may comprise a TotalImmunity Identification and Forbidden-Block status at 1010. As indicated at the method may proceed to 960.

In one embodiment, if the user has sufficient rights, the user may decide to override the system and execute the process file without any administrator approvals. To do so, the user may require a special key generated by the protection software that is assigned to only that user. For example, override keys may be generated by the administrator and may be distributed to certain users. In some embodiments, when a process file is not approved to execute on a Protected Machine 120, a dialog may be displayed to the user indicating this. At this time, a user may enter an override key in response to the dialog to override this decision and allow the process file to execute. It is noted that the use of override keys should be used with caution as this circumvents the protection provided by the protection software. In one embodiment, override keys may not be used or allowed in the protection software. In some embodiments, when a process file is not approved to execute on a Protected Machine 120, a dialog may be displayed to the user indicating this. At this time, a user may enter an override key in response to the dialog to override this decision and allow the process file to execute.

If the blocked request to the forbidden process file may be overridden, an override message may be displayed, as indicated at 1020. An entry in UMF 278 may be stored which may comprise a TotalImmunity Identification and Forbidden-Block status at 1030. An information request packet (IRP) may be set as “pending” and wait until an input/output control (IOCTL) message from UMS 272 is received, at 1040. In some embodiments, an IRP may comprise various flags, an input/output (I/O) status, a requester mode, a cancel subroutine or destructor, and a thread identification, among others.

As indicated at 1050, it may be determined if the forbidden process file is allowed to execute. If the forbidden process file is allowed to execute, it may be determined if the forbidden process request is to be logged at 1060. If the forbidden process request is to be logged, information associated with the forbidden process request may be stored in UMF 278 at 1070. For instance, information associated with the forbidden process request may comprise a TotalImmunity Identification and Forbidden-RunKey status. The forbidden process request may be passed through to be executed at 1080. If the forbidden process request is not to be logged, the forbidden process request may be passed through to be executed at 1080.

If the forbidden process file is not allowed to execute, it may be determined if the forbidden process request is to be logged at 1090. If the forbidden process request is to be logged, information associated with the forbidden process request may be stored in UMF 278 at 1100. For instance, information associated with the forbidden process request may comprise a TotalImmunity Identification and Forbidden-BlockKey status. The forbidden process request may be denied at 1120. If the forbidden process request is not to be logged, the forbidden process request may be denied at 1120.

If a user is not currently logged in, at 900, it may be determined if the forbidden process file is allowed to execute as indicated at 1130. If the forbidden process file is allowed to execute, the method may proceed to 920. If the forbidden process file is not allowed to execute, it may be determined if the forbidden process file is to be blocked at 1140. If the forbidden process file is to be blocked, the method may proceed to 960. If the forbidden process file is not to be blocked, the forbidden process file may be executed in a quarantine at 1150. In some embodiments, executing the process file in the quarantine may comprise denying the process file write access (e.g., write access to files and/or registry entries) and/or denying access to a network, among others. At 1160, the forbidden process file may be placed on a quarantine list, and the method may proceed to 920.

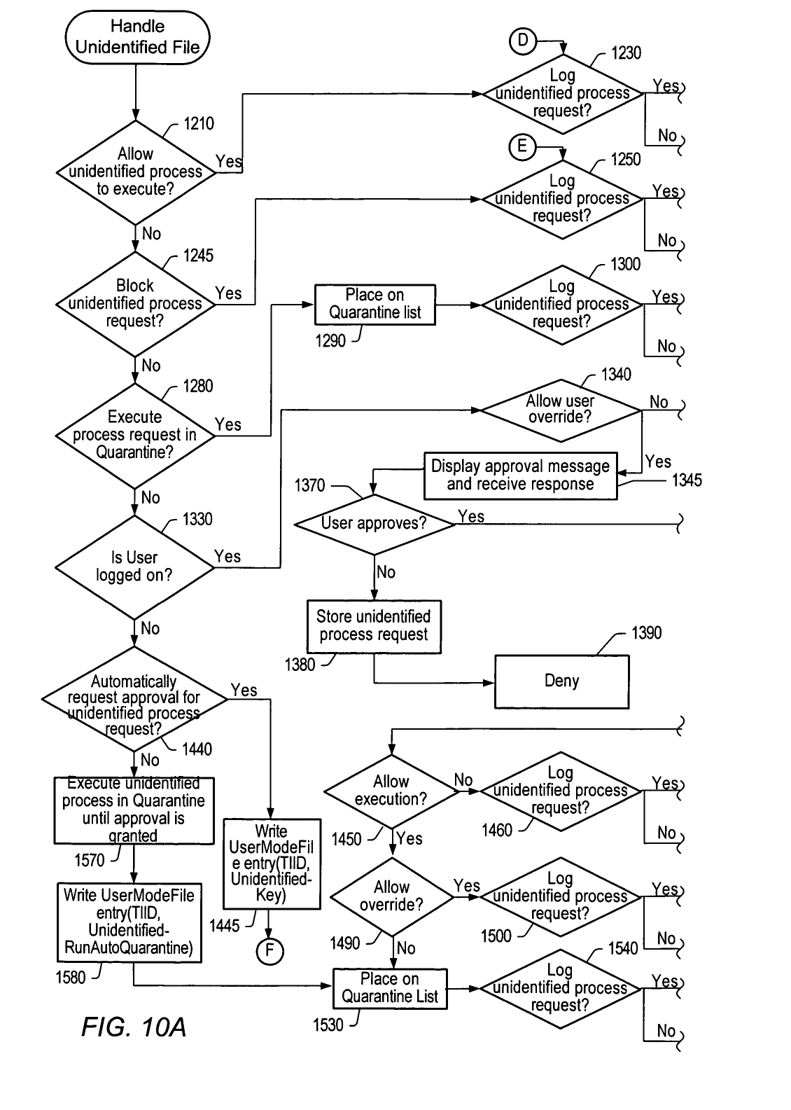

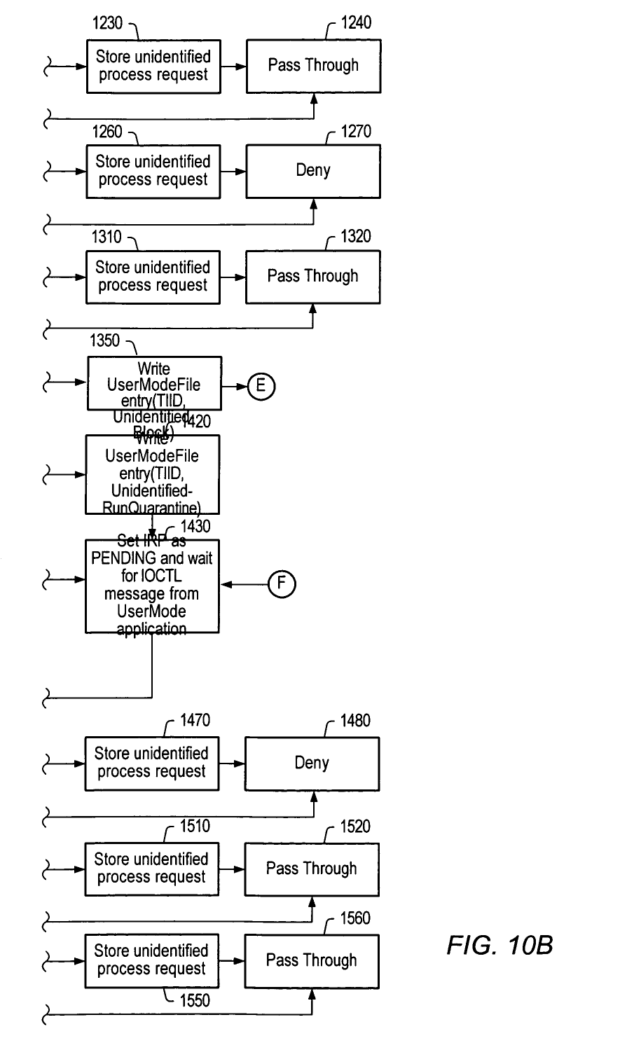

FIGS. 10A-10B—Handle Unidentified Process Request

FIGS. 10A-10B illustrate a flowchart diagram of a method for handling a request to execute a process file which is unidentified (e.g., not on the Approved List or the Forbidden List), according to various embodiments. It is noted that in various embodiments one or more of the method elements may be performed concurrently, in a different order, or may be omitted. Additional method elements may be performed as desired.

In various embodiments, method elements 1210-1580 may be performed with reference to 790 of FIG. 7. At 1210, it may be determined if the unidentified process file is allowed to execute. If the unidentified process file is allowed to execute, it may be determined if the unidentified process request is to be logged at 1230. If the unidentified process request is to be logged, information associated with the unidentified process request may be stored in UMF 278 at 1230. For instance, information associated with the unidentified process request may comprise a TotalImmunity Identification and Unidentified-Run status. The unidentified process request may be passed through to be executed at 1240. If the unidentified process request is not to be logged, unidentified process request may be passed through to be executed at 1240.

If the unidentified process file is not allowed to execute, it may be determined to block the unidentified process request at 1245. For example, various configurations of the protection software may comprise blocking all unidentified process files from executing. If the unidentified process request is to be blocked, it may be determined if the unidentified process request is to be logged at 1250. If the unidentified process request is to be logged, information associated with the unidentified process request may be stored in UMF 278 at 1260. For instance, information associated with the unidentified process request may comprise a TotalImmunity Identification and Unidentified-Block status. Execution of the unidentified process file may be denied at 1270. If the unidentified process request is not to be logged, the unidentified process request may be denied at 1270.

If the unidentified process request is not to be blocked, it may be determined if the unidentified process file is to be executed in a quarantine at 1280. If the unidentified process file is to be executed in a quarantine, information associated with the unidentified process request may be place on a quarantine list at 1290. As indicated at 1300, it may be determined if the unidentified process request is to be logged at 1300. If the unidentified process request is to be logged, information associated with the unidentified process request may be stored in UMF 278 at 1310. For instance, information associated with the unidentified process request may comprise a TotalImmunity Identification and Unidentified-RunQuarantine status. The unidentified process request may be passed through to be executed in the quarantine at 1320. If the unidentified process request is not to be logged, the unidentified process request may be passed through to be executed in the quarantine at 1320. In some embodiments, executing the process file in the quarantine may comprise denying the process file write access (e.g., write access to files and/or registry entries) and/or denying access to a network, among others.

If the unidentified process file is not to be executed in a quarantine, it may be determined if a user is logged on to the computer system at 1330. If a user is logged on to the computer system, it may be determined if a user override is allowed at 1340. There may be times when a user knows that a process file is ‘safe’ and wants to execute it, but the process is on the Forbidden list. If a user override is not allowed, an entry may be stored in UMF 278 which may comprise a TotalImmunity Identification and Unidentifed-Block status at 1350. The method may proceed to 1250.

If a user override is allowed, an approval message may be displayed and a response to the approval message may be received at 1345. If the user does not approve, information associated with the unidentified process request may be stored in UMF 278 at 1380. For instance, information associated with the unidentified process request may comprise a TotalImmunity Identification and Unidentified-BlockKey status. The unidentified process request may be denied at 1390.

If the user approves, an entry may be stored in UMF 278 which may comprise a TotalImmunity Identification and Unidentified-RunQuarantine status at 1420. An IRP may be set as “pending” and wait until an IOCTL message from a UserMode application is received at 1430.

As indicated at 1450, it may be determined if the unidentified process file is allowed to be executed. If the unidentified process file is not allowed to execute, it may be determined if the unidentified process request is to be logged at 1460. If the unidentified process request is to be logged, information associated with the unidentified process request may be stored in UMF 278 at 1470. For instance, information associated with the unidentified process request may comprise a TotalImmunity Identification and Unidentified-BlockKey status. The unidentified process request may be denied at 1480. If the unidentified process request is not to be logged, execution of the unidentified process file may be denied at 1480.

If the unidentified process file is allowed to execute, it may be determined if an override is allowed at 1490. If an override is allowed, it may be determined if the unidentified process request is to be logged at 1500. If the unidentified process request is to be logged, information associated with the unidentified process request may be stored in UMF 278 at 1510. For instance, information associated with the unidentified process request may comprise a TotalImmunity Identification and Unidentified-RunKey status. The unidentified process request may be passed through to be executed at 1520. If the unidentified process request is not to be logged, the unidentified process request may be passed through to be executed at 1520.

If an override is not allowed, the unidentified process file may be stored in a quarantine list at 1530. As indicated at 1540, it may be determined if the unidentified process request is to be logged. If the unidentified process request is to be logged, information associated with the unidentified process request may be stored in UMF 278 at 1550. For instance, information associated with the unidentified process request may comprise a TotalImmunity Identification and Unidentified-RunKeyQuarantine status. The unidentified process request may be passed through to be executed at 1560. If the unidentified process request is not to be logged, the unidentified process request may be passed through to be executed at 1560.

As described above at 1330, it may be determined if a user is logged on. If a user is not logged in, it may be determined if approval for the unidentified process request may be automatically obtained at 1440. If so, the method may proceed to 1445 where an entry may be stored in UMF 278 which may comprise a TotalImmunity Identification and Unidentifed-Key status, and the method may proceed to 1430. If not, approval to execute unidentified process file in a quarantine may be granted at 1570. An entry may be stored in UMF 278 which may comprise a TotalImmunity Identification and Unidentifed-RunAutoQuarantine status at 1580, and the method may proceed to 1530.

FIGS. 11-13—Diagrams of File Comprising Configuration, Approved List, and Forbidden List Information

FIGS. 11-13 are exemplary diagrams illustrating, respectively, a configuration file, an Approved List file, and a Forbidden List file, according to various embodiments.

Some configuration settings may comprise:

Approved-Log—0=> do not log approved process-requests, or
1=>log approved process-requests;

Forbidden-Log—0=>do not log forbidden process-requests, or
1=> log forbidden process-requests;

Unidentified-Log—0=> do not log unidentified process-requests or
1=>log unidentified process-requests

Forbidden-IfUser—1=>if a user is logged on, allow forbidden process-requests to run,
2=>if a user is logged on, block forbidden process-requests,
3=>if a user is logged on, block forbidden process-requests and display message to user, or
4=> if a user is logged on, display key override message;

Forbidden-IfNoUser—1=> if no user is logged on, allow process-requests to run,
0x10=>if no user is logged on, allow process-requests to run, but run Quarantined, or
2=> if no user is logged on, block forbidden process-requests;

Forbidden-Msg—text of message to display for forbidden process-request when user is logged on;

Unidentified-IfUser—1=> if a user is logged on, allow process-requests to run,
0x10=>if a user is logged on, allow unidentified process-requests to run, but run Quarantined,
2=>if a user is logged on, block unidentified process-requests,
3=>if a user is logged on, block unidentified process-requests and display message to user,
4=>if a user is logged on, display to the user to allow approval to be requested, or
5=> if a user is logged on, display key override message,
0x50=> if a user is logged on, display key override message, if override is supplied, run Quarantined;

Unidentified-IfNoUser—1=> if no user is logged on, allow unidentified process-requests run
0x10=>if no user is logged on, allow unidentified process-requests to run, but run Quarantined,
2=>if no user is logged on, block process-requests,
6=>if no user is logged on, auto request approval of unidentified process-requests, or
0x60=> if no user is logged on, auto request approval of unidentified process-requests and run Quarantined untilapproval is granted;

Unidentified-Msg—text of message to display for unidentified process-request when user is logged on.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed:

1. A computer-implemented method for protecting one or more computer systems from unwanted software, the method comprising:
receiving a request to execute a first process file on a first computer system;
determining if the first process file is on an approved list;
allowing the first process file to run on the first computer system if the first process file is on the approved list.

2. The method of claim 1,
wherein the first process file is not allowed to run on the first computer system if the first process file is not on the approved list.

3. The method of claim 1, further comprising:
determining that the first process file is not on the approved list;
receiving user input allowing the first process file to run on the first computer system after said determining that the first process file is not on the approved list.

4. The method of claim 1, further comprising:
determining if the first process file is on a forbidden list;
blocking execution of the first process file if the first process file is on the forbidden list.

5. The method of claim 4, further comprising:
logging information about the first process file if the first process file is on the forbidden list.

6. The method of claim 4, further comprising:
if the first process file is not on the approved list or the forbidden list, then automatically requesting approval of the first process file.

7. The method of claim 4, further comprising:
if the first process file is not on the approved list or the forbidden list, then determining if approval should be requested for the first process file.

8. The method of claim 4, further comprising:
requesting approval for the first process file if the first process file is not on the approved list or the forbidden list; and
delaying execution of the first process file until the approval is received.

9. The method of claim 4, if the first process file is not on the approved list or the forbidden list, then executing the first process file in a quarantined environment, wherein in the quarantined environment the first process file is not allowed access to one or more resources of the first computer system.

10. The method of claim 9, wherein the one or more resources comprise one or more of:
network access;
registry update access;
file write access;
file execution access;

11. The method of claim 9, further comprising:
configuring a level of the quarantined environment in response to user input, wherein the level of the quarantined environment determines which of the one or more resources are allowed by the first computer system.

12. The method of claim 1, further comprising:
executing a software agent on the first computer system, wherein the software agent performs said determining if the first process file is on an approved list and said allowing the first process file to run if the first process file is on the approved list

13. The method of claim 1,
wherein the approved list comprises a list of known good process files.

14. The method of claim 1, further comprising:
receiving information from a server computer to update the approved list, wherein the information from the server comprises a list of approved process files from at least one software vendor.

15. The method of claim 1, further comprising:
determining if the first process file is on a forbidden list;
receiving first information from a server computer to update the approved list, wherein the first information from the server comprises a list of approved process files from at least one software vendor;
receiving second information from a server computer to update the forbidden list, wherein the second information from the server comprises a list of forbidden process files.

16. The method of claim 1, further comprising:
creating the approved list, wherein said creating comprises:
configuring a second computer system with a plurality of process files that are used by the first computer system, wherein the second computer system is managed to prevent unwanted software from being stored on the second computer system;
determining process files stored on the second computer system after said configuring; and
storing information regarding the determined process files in the approved list based on said determining process files stored on the second computer system.

17. The method of claim 16, further comprising:
distributing the approved list to the first computer system after said creating the approved list.

18. The method of claim 16,
wherein said creating the approved list based on the process files determined to be stored on the second computer system comprises, for each of at least a subset of the determined process files:
requesting approval for a determined process file: and
adding the determined process file to the approved list if the approval is received.

19. The method of claim 16, further comprising:
installing a new process file on the second computer system;
automatically adding the new process file to the approved list after said installing.

20. The method of claim 16, further comprising:
installing a new process file on the second computer system;
requesting approval for the new process file: and
adding the determined process file to the approved list if the approval is received.

21. The method of claim 16, further comprising:
periodically performing:
determining new process files stored on the second computer system after said configuring; and
updating the approved list based on the new process files determined to be stored on the second computer system.

22. The method of claim 16, further comprising:
receiving first information from a server computer to update the approved list, wherein the first information from the server comprises a list of approved commercial process files; and
updating the approved list based on the first information.

23. The method of claim 22, further comprising:
storing a forbidden list, wherein the forbidden list comprises a list of known bad process files;
receiving second information from a server computer to update the forbidden list, wherein the second information from the server comprises a list of forbidden process files; and
updating the forbidden list based on the second information.

24. A memory medium comprising program instructions for protecting one or more computer systems from unwanted software, wherein the program instructions are executable to implement:
receiving a request to execute a first process file on a first computer system;
determining if the first process file is associated with an entry of an approved list of process files;
if the first process file is associated with an entry of the approved list of process files, executing the first process file on the first computer system; and
if the first process file is not associated with an entry of the approved list of process files, preventing execution of the first process file.

25. The memory medium of claim 24, wherein the program instructions are further executable to implement:
determining if the first process file is on a forbidden list;
wherein said preventing execution of the first process file is performed if the first process file is not on the approved list and is on the forbidden list.

26. The memory medium of claim 24, wherein the program instructions are further executable to implement:
determining that the first process file is not on the approved list;
receiving user input allowing the first process file to run on the first computer system after said determining that the first process file is not on the approved list.

27. The memory medium of claim 24, wherein said determining if the first process file is associated with an entry comprises:
determining a hash value for the first process file, wherein each entry of the Approved List of process files comprises a hash value;
comparing the hash value for the first process file with one or more of the hash values of the entries of the approved list.

28. The memory medium of claim 24, wherein said determining if the first process file is associated with the corresponding entry comprises:
determining a file name for the first process file, wherein each entry of the Approved List comprises a file name;
comparing the file name for the first process with one or more of the file names of the entries of the Approved List.

29 The memory medium of claim 24, further comprising:
determining a second process file associated with the first process file; and
determining if the second process file is associated with a an entry of the approved list of process files;
wherein said executing the first process file on the first computer system is performed if the second process file is associated with an entry of the approved list of process files;
wherein said preventing execution is performed if the second process file is not associated with an entry of the approved list of process files.

30. The memory medium of claim 24, further comprising:
opening a file which comprises the Approved List, wherein the one or more entries of the Approved List each comprises process file identification information and digital signature information, wherein the digital signature information is usable to determine if the entry is valid; and
for each entry of the one or more entries of the Approved List performing:
reading the process file identification information;
reading the digital signature information;
determining if the entry is valid based on the digital signature information; and
storing the process file identification information in a memory medium if the entry is valid.

31. A method for creating an approved list of process files useable for protecting one or more computer systems from unwanted software, the method comprising:
configuring a first computer system with a plurality of process files that are used by the one or more computer systems, wherein the first computer system is managed to prevent unwanted software from being stored on the first computer system;
determining process files stored on the first computer system after said configuring; and
storing information regarding the determined process files in the approved list based on said determining;
wherein the approved list is useable for protecting one or more computer systems from unwanted software.

32. The method of claim 31, further comprising:
distributing the approved list to the one or more computer systems after said creating the approved list.

33. The method of claim 31,
wherein said creating the approved list based on the process files determined to be stored on the first computer system comprises, for each of at least a subset of the determined process files:
requesting approval for a determined process: and
adding the determined process file to the approved list if the approval is received.

34. The method of claim 31, further comprising:
installing a new process file on the first computer system;
automatically adding the new process file to the approved list after said installing.

35. The method of claim 31, further comprising:
installing a new process file on the first computer system;
requesting approval for the new process file; and
adding the determined process file to the approved list if the approval is received.

36. The method of claim 31, further comprising:
periodically performing:
determining new process files stored on the first computer system after said configuring; and
updating the approved list based on the new process files determined to be stored on the first computer system.

37. The method of claim 31, further comprising:
receiving first information from a server computer to update the approved list, wherein the first information from the server comprises a list of approved process files from at least one software vendor; and
updating the approved list based on the first information.

38. The method of claim 37, further comprising:
storing a forbidden list, wherein the forbidden list comprises a list of known bad process files;
receiving second information from a server computer to update the forbidden list, wherein the second information from the server comprises a list of forbidden process files; and
updating the forbidden list based on the second information.

39. A system for protecting a plurality of computer systems from unwanted software, the system comprising:
a server computer system which comprises a processor and a memory medium, wherein the memory medium stores an approved list, wherein the approved list comprises a list of processes approved for execution on each of the plurality of computer systems;
a plurality of computer systems coupled to the server computer system over a network;
wherein the server computer system is operable to distribute an agent software program to a respective computer system of each of the plurality of computer systems;
wherein the server computer system is further operable to distribute the approved list to a respective computer system of each of the plurality of computer systems;
wherein each agent software program comprises program instructions executable on the respective computer system to:
receive a request for storage and/or execution of a process;
determine if the process is on the approved list; and
allow the process to run on the respective computer system if the process is on the approved list.
